(19) United States
(12) Patent Application Publication
(10) Pub. No.: US 2008/0037022 A1
(43) Pub. Date: Feb. 14, 2008

(54) Surface Plasmon Resonance Sensor

(76) Inventors: Takeo Nishikawa, Kyoto (JP); Shigeru Aoyama, Kyoto (JP); Tomohiko Matsushita, Osaka (JP); Shigemi Norioka, Osaka (JP); Tetsuichi Wazawa, Miyagi (JP)

Correspondence Address: OSHA LIANG L.L.P., 1221 MCKINNEY STREET, SUITE 2800, HOUSTON, TX, 77010, US

(21) Appl. No.: 10/589,044

(22) PCT Filed: Feb. 10, 2005
(86) PCT No.: PCT/JP05/02045

§ 371 Date: Jul. 2, 2007

(30) Foreign Application Priority Data
Feb. 13, 2004 (JP) 2004-036424

(51) Int. Cl. G01N 21/55; B05D 5/12; G02B 5/28

(52) U.S. Cl. 356/445; 359/839; 427/123; 428/457; 977/773

(57) ABSTRACT

In a surface plasmon resonance sensor including a chip with a substrate 102 and a metal layer 103, a prism 104, an optical system 105 serving as a light source, and a light detector 106, the metal layer 103 is configured by a flat part 109 formed into a thin film, and convex parts formed from metal particles 110 and the like arranged spaced apart from each other. When light enters the metal layer 103 of such configuration, resonance angle arising from the flat part 109 and the convex parts are respectively obtained. The change in index of refraction of a medium contacted by the metal layer is detected from such resonance angle.

### TECHNICAL FIELD

The present invention relates to surface plasmon resonance (SPR) sensors, more specifically, to a surface plasmon resonance sensor suited for detecting the interaction of biomolecules such as protein and DNA.

### BACKGROUND ART

Recently, the surface plasmon resonance sensor is used as the sensor for detecting the presence and the extent of the interaction of the biomolecules.

FIG. 1 shows a conventional surface plasmon resonance sensor 1. The surface plasmon resonance sensor 1 includes a substrate 2 made of glass and the like, a metal thin film 3 formed on the substrate 2, a prism 4 arranged on the side of the substrate 2 not formed with the metal thin film 3, an optical system 5 capable of entering the light at various angels with respect to the interface of the metal thin film 3 and the substrate 2, and a light detector 6 for measuring the intensity of the light reflected at the interface of the metal thin film 3 and the substrate 2. The metal thin film 3 contacts the sample solution, and ligand 8 such as an antigen in the sample solution interacts with the acceptor 7 such as an antibody immobilized at the surface of the metal thin film 3.

When the light from the optical system 5 enters the prism 4 so as to be totally reflected at the interface of the metal thin film 3 and the substrate 2, evanescent wave having electric field distribution is produced at the surface of the metal thin film 3. When the wave number and the frequency of the evanescent light match the wave number and the frequency of the surface plasmon, they resonate and the energy of the incident light transforms to the surface plasmon, whereby the reflected light decreases.

The angle of incidence (resonance angle) for the resonance to occur depends on the index of refraction of the surface of the metal thin film 3. The resonance angle changes since the index of refraction of the surface changes when the acceptor 7 immobilized at the metal thin film 3 and the ligand 8 in the sample solution interact. The interaction of the biomolecules is detected by measuring such change of angle. FIG. 2 shows an example of the change in reflectivity measured before and after the reaction between the acceptor 7 and the ligand 8 by means of the surface plasmon sensor 1.

A local plasmon resonance sensor of irradiating the light with respect to the substrate in which the metal particles instead of the metal thin film are fixed in a film form, and measuring the absorption of the light transmitted through the metal particles to detect the change in the index of refraction in the vicinity of the surface of the metal particles is proposed (patent document 1).

Patent Document: Japanese Patent No. 3452837

### DISCLOSURE OF THE INVENTION

### Problems to be Solved by the Invention

However, as the surface plasmon resonance sensor 1 shown FIG. 1 is influenced by the change in the index of refraction of up to the distance of about 200 nm from the metal thin film, not only the change in the index of refraction based on the interaction of the biomolecules immobilized to the metal thin film, but also the change in the index of refraction based on the change in concentration, pH, temperature and the like of the liquid solution part is detected as noise.

Furthermore, although the local plasmon sensor disclosed in patent document 1 uses the metal particle film instead of the metal thin film to localize the generating electric field in the vicinity of the surface of the metal particles and to reduce the influence of the change in the index of refraction at the liquid solution part, it does not eliminate the influence of the liquid solution part, and thus to what extent the change at the liquid solution part influences the measurement result is not known.

### Means for Solving the Problems

The present invention aims to, in view of the technical problems described above, detect the change in the index of refraction based on the interaction of the molecules at the metal surface and the change in the index of refraction based on the change at the solvent part.

The surface plasmon resonance sensor chip according to the present invention includes a transparent substrate; and a metal layer including concave parts or convex parts on a surface and a flat part positioned between the concave parts or the convex parts, and formed so as to cover the surface of the substrate.

In one aspect of the surface plasmon resonance sensor chip according to the present invention, the substrate is a substrate with a flat surface, and the convex parts are a plurality of metal particles immobilized spaced apart from each other on a metal thin film, which is the flat part.

In another aspect of the surface plasmon resonance sensor chip according to the present invention, the substrate is a substrate with a flat surface, and the concave parts or the convex parts are a plurality of microscopic concave parts and convex parts formed spaced apart from each other on a metal thin film, which is the metal layer, the concave part not passing through the metal thin film.

In another aspect of the surface plasmon resonance sensor chip according to the present invention, a plurality of microscopic convex parts or microscopic concave parts are formed spaced apart from each other on one surface of the substrate, and the metal layer is formed on the one surface of the substrate so as to reflect the shape of the microscopic convex parts or the microscopic concave parts.

In another further aspect of the surface plasmon resonance sensor chip according to the present invention, the material of the metal layer is gold or silver.

A method of manufacturing the surface plasmon resonance sensor chip according to the present invention includes the steps of forming a metal thin film on one surface of a substrate through sputtering or deposition; chemically modifying the surface of the metal thin film; and immersing the chemically modified substrate into a liquid solution of metal particles.

A method of manufacturing the surface plasmon resonance sensor chip according to the present invention includes the steps of immersing one surface of a substrate in a liquid solution of aminosilane coupling agent; immersing the substrate into a liquid solution of metal particles; cleaning the substrate; and forming a metal thin film on the one surface through sputtering or deposition.

The surface plasmon resonance sensor according to the present invention includes a surface plasmon resonance sensor chip according to the present invention; a prism arranged on the side of the chip not formed with the metal layer; a light source for irradiating light on the chip through the prism; and a light detector for measuring the reflectivity of the light by the metal layer.

A method of measurement of biomolecules according to the present invention is a method of measurement of biomolecules of irradiating the light from the optical system to the surface plasmon resonance sensor chip according to the present invention, totally reflecting the light at the interface of the metal layer and the substrate of the chip, and measuring the intensity of reflected light with the light detector; wherein the presence or the extent of interaction of biomolecules is measured from the change in intensity of the reflected light with respect to the change in frequency of the irradiated light.

A method of detecting change in the index of refraction according to the present invention is a method of detecting change in index of refraction of irradiating the light from the optical system to the surface plasmon resonance sensor chip according to the present invention, totally reflecting the light at the interface of the metal layer and the substrate of the chip, and measuring the intensity of reflected light with the light detector; wherein the change in index of refraction based on interaction of molecules at the metal layer surface, and change in index of refraction based on interaction with solvent in the vicinity of the metal layer are respectively detected by measuring the change in the resonance angle of the reflected light.

### EFFECT OF THE INVENTION

The surface plasmon resonance sensor of the present invention has the metal layer formed on one surface of the prism configured by a flat part formed into a thin film, and convex parts made up of metal particles and the like arranged spaced apart from each other, where the resonance angles arising from the flat part and the convex parts are respectively obtained when the light is entered into the metal layer of such configuration. The change in the index of refraction based on the interaction of the biomolecules at the metal surface, and the change in the index of refraction based on the change at the solvent part are respectively detected by using such features.

### BRIEF DESCRIPTION OF THE DRAWINGS

FIG. 1 shows a schematic side view of a conventional surface plasmon resonance sensor;

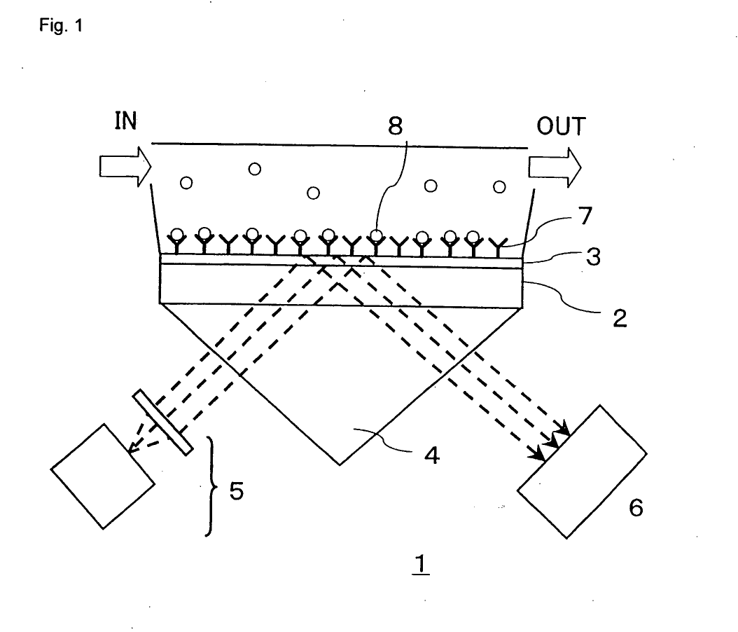

FIG. 2 shows a graph showing the relationship between the angle of incidence and the reflectivity of the incident light in the conventional surface plasmon resonance sensor;

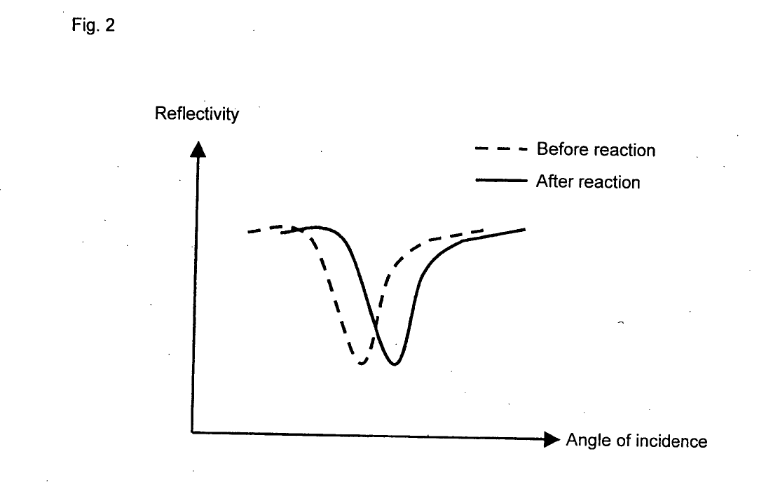

FIG. 3 shows a schematic side view of a surface plasmon resonance sensor according to a first embodiment of the present invention;

FIG. 4 shows a view schematically showing the electric field generated at the surface of the metal surface;

FIG. 5 shows a graph showing the dispersion relationship between the surface plasmon and the incident light;

FIG. 6 shows a graph showing a dispersion relationship between the surface plasmon of hybrid mode and the incident light;

FIG. 7 shows a graph showing the measurement result of the reflectivity measured in the embodiment of the present invention;

FIG. 8 shows a partially enlarged view of the surface plasmon resonance sensor of FIG. 3;

FIG. 9 shows a schematic side view of a surface plasmon resonance sensor according to a second embodiment of the present invention; and

FIG. 10 shows a schematic side view of a surface plasmon resonance sensor according to a third embodiment of the present invention.

### DESCRIPTION OF REFERENCE NUMERALS

1, 101, 201, 301 surface plasmon resonance sensor
2, 102 substrate
3, 103 metal layer
4, 104 prism
5, 105 optical system
6, 106 light detector
7, 107 acceptor
8, 108 ligand
109 flat part
110 metal particle
111 sample solution

### BEST MODE FOR CARRYING OUT THE INVENTION

The preferred embodiment of the present invention will now be described with reference to the drawings.

### EXAMPLE 1

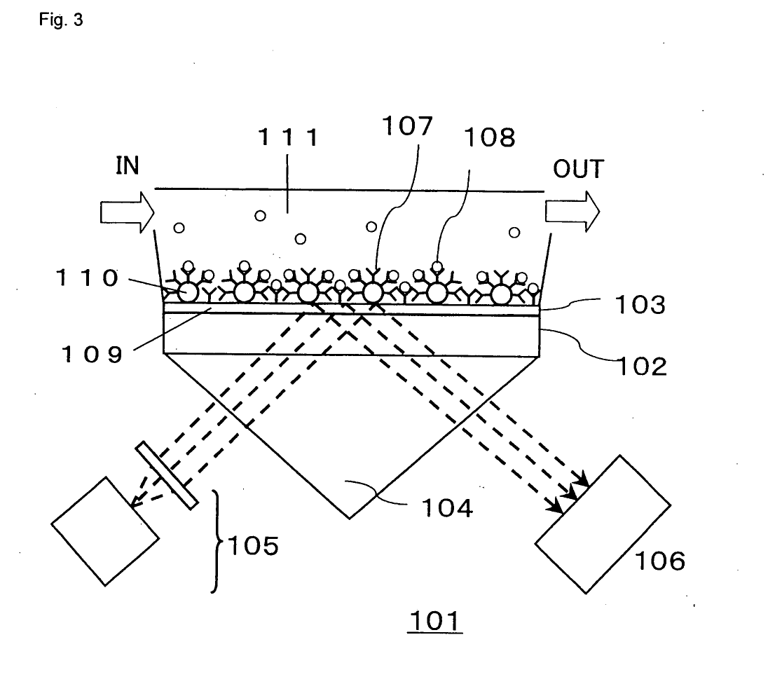

FIG. 3 shows a schematic side view of a surface plasmon resonance sensor 101 according to a first embodiment of the present invention. The surface plasmon resonance sensor 101 includes a substrate 102 made of glass and the like, a metal layer 103 formed on the substrate 102, a prism 104 arranged on the side of the substrate 102 not formed with the metal layer 103, an optical system 105 for entering the light to the interface of the metal layer 103 and the substrate 102, and a light detector 106 for measuring the intensity of the light reflected at the interface of the metal layer 103 and the substrate 102. The optical system 105 may enter the light of a certain wavelength at various angels of incidence, or may enter the light of various wavelengths at a constant angle of incidence.

The metal layer 103 is configured by a flat part 109 formed into a thin film, and metal particles 110 arranged spaced apart from each other in the present embodiment, where the flat part 109 is exposed between the adjacent metal particles 110. The thickness of the flat part 109 is preferably between 20 and 60 nm, and the diameter of the metal particles 110 is preferably between 20 and 150 nm. The metal layer 103 is typically made of gold or silver but is not limited thereto. The acceptor 107 such as an antibody is immobilized at the surface of the metal layer 103. The metal layer 103 contacts the sample solution 111 containing ligand 8 such as an antigen, and the ligand 108 interacts with the acceptor 107 at the surface of the metal layer 103.

In such configuration, the evanescent wave is produced at the surface of the metal layer 103 when the light from the optical system 5 enters the prism 104 so as to be totally reflected at the interface of the metal layer 103 and the substrate 102. When the wave number and the frequency of the evanescent light, and the wave number and the frequency of the surface plasmon match, they resonate and the reflected light decreases. The reflectivity of the reflected light is measured by the light detector 106.

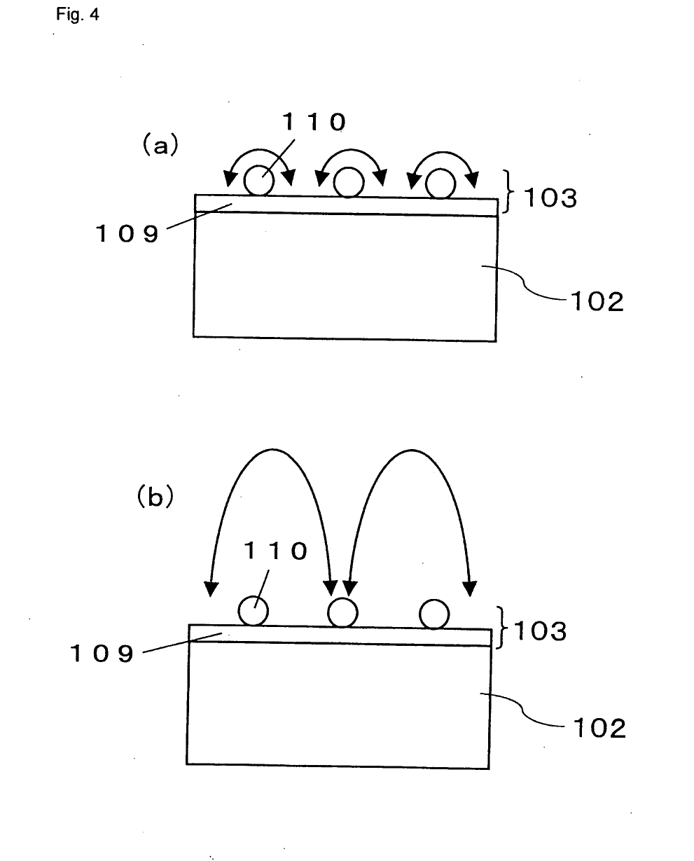

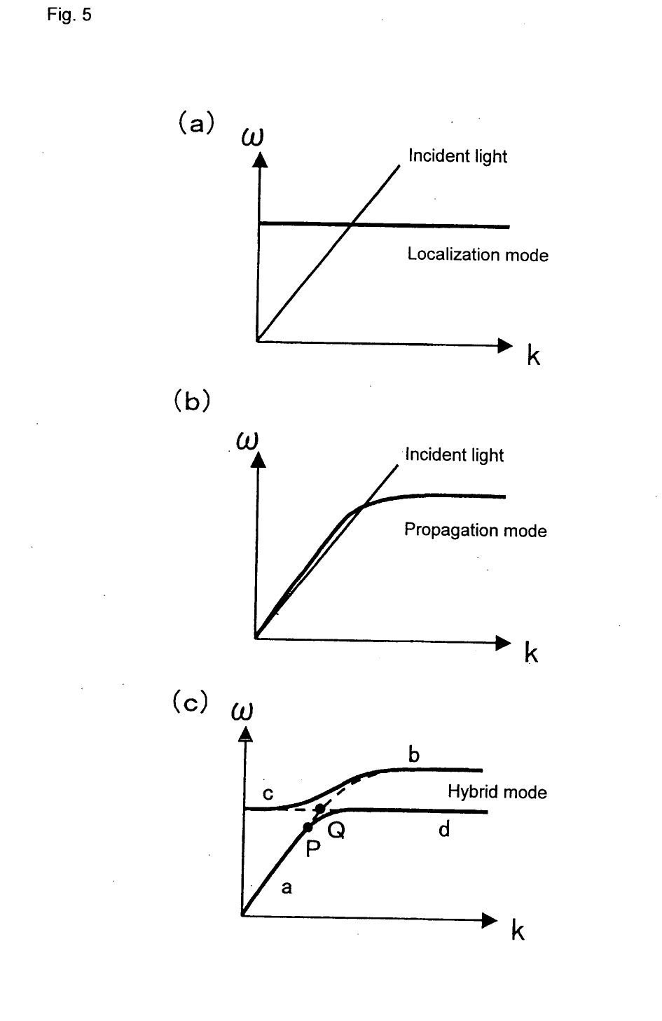

The electric field of the surface plasmon excited at the surface of the metal layer 103 will now be described. FIG. 4 schematically shows the state of the electric field generated at the surface of the metal layer 103 with two headed arrows. FIG. 4(a) shows the electric field (localization mode) localized in the vicinity of the surface of the metal particles 110 (range of about the radius (several tens nm) of the metal particles). FIG. 4(b) shows the electric field (propagation mode) present in a range of about a several hundred nm from the surface of the flat part 109. That is, the localization mode arises from the metal particles 110, and the propagation mode arises from the flat part 109. Although the two modes are separately shown in FIGS. 4(a) and 4(b), both modes are simultaneously produced and coexist. FIG. 5 is a graph showing the relationship between each mode of the surface plasmon and the incident light, where the vertical axis represents angular frequency (ω), and the horizontal axis represents wave number (k=2π/λ, λ is wavelength). FIG. 5(a) shows the relationship between the surface plasmon of localization mode and the incident light, and FIG. 5(b) shows the relationship between the surface plasmon of propagation mode and the incident light, where both modes respectively resonate with the incident light at one point.

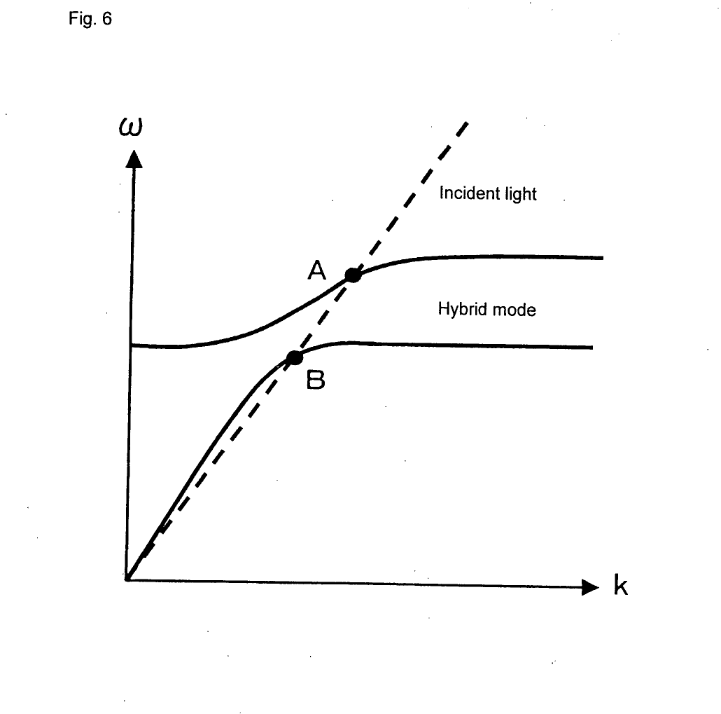

When both the localization mode and the propagation mode exist as in the present embodiment, the mode of the surface plasmon becomes a hybrid mode (a-d, c-b) expressed by the dispersion function as shown in FIG. 5(c). In FIG. 5(c), Q represents the intersection between the localization mode and the propagation mode, where c-Q-d represents the localization mode, and a-P-Q-b represents the propagation mode. The graph showing the relationship between the hybrid mode and the incident light is shown in FIG. 6. As apparent from FIG. 6, the surface plasmon of hybrid mode resonates with the incident light at two points (A, B). The incident light is expressed by ω=(c/n)k, where n is the index of refraction of the substrate 102, and c is the speed of light in vacuum. When the angle of incidence with respect to the substrate 102 is constant, the resonance of localization type occurs in the vicinity of the metal particles 110 if the wavelength of the light entering the substrate 102 is the resonance wavelength of the short side corresponding to point A, and the resonance of propagation type by the flat part 109 occurs if the wavelength entering the substrate 102 is the resonance wavelength of the long side corresponding to point B.

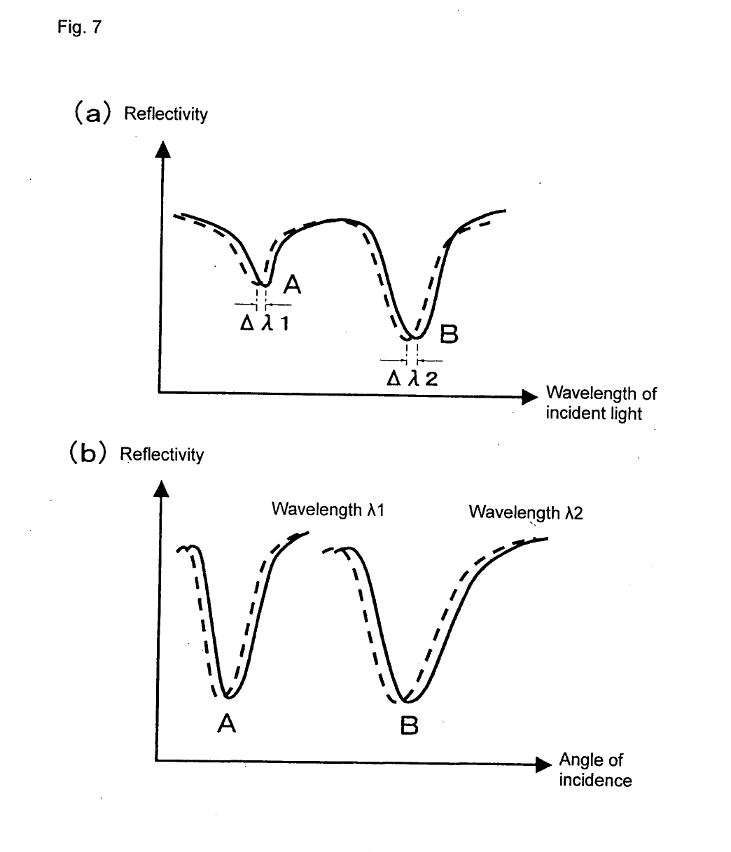

However, two resonance peaks (A, B) are obtained, as shown in FIG. 7(a), when entering the light of various wavelengths at a constant angle of incidence and measuring the reflectivity. The dotted light shows the measurement result of before the reaction between the acceptor 107 and the ligand 108, and the solid line shows the measurement result of after the reaction. Peak A arises from the electric field of localization mode and corresponds to the resonance at point A in FIG. 6. Peak B arises from the electric field of propagation mode and corresponds to the resonance at point B in FIG. 6.

Furthermore, one resonance peak (A. B) is respectively obtained, as shown in FIG. 7(b), when entering the light of two different wavelengths at various angles of incidence and measuring the reflectivity. The dotted line shows the measurement result of before the reaction between the acceptor 107 and the ligand 108, and the solid line shows the measurement result of after the reaction. Peak A of short wavelength (wavelength λ1) arises from the electric field of localization mode and corresponds to the resonance at point A in FIG. 6. Peak B of long wavelength (wavelength λ2) arises from the electric field of propagation mode and corresponds to the resonance at point B in FIG. 6.

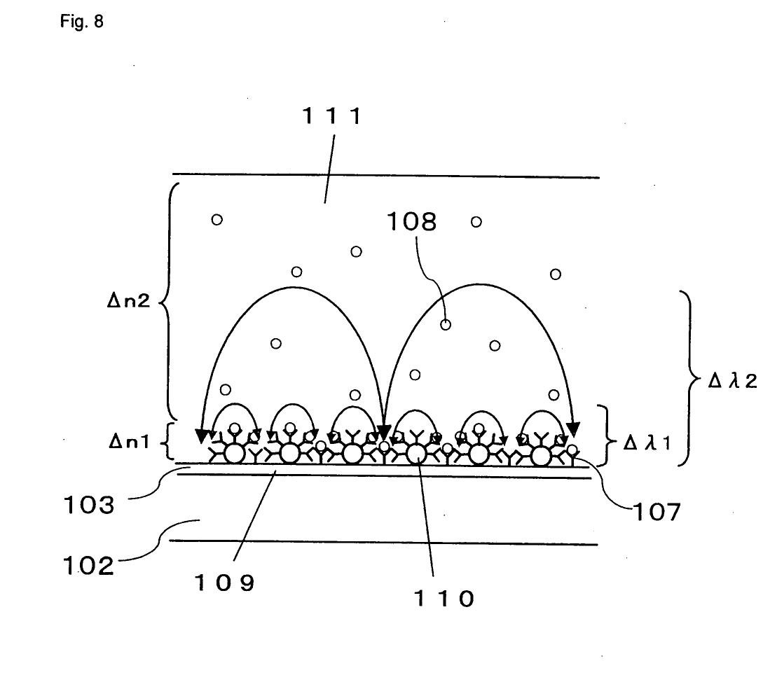

As shown in FIG. 8, the changes (Δλ1, Δλ2) in resonance peak that occur when entering the light of various wavelengths at a constant angle of incidence and measuring the change in reflectivity before and after the reaction (FIG. 7(a)) are respectively influenced by both the change (Δn1) in the index of refraction based on the interaction between the acceptor 107 and the ligand 108 at the surface of the metal layer 103, and the change (Δn2) in the index of refraction at the solvent part (sample solution 111). If Δλ1 and Δλ2 are respectively obtained as a function of Δn1, Δn2, Δn1 and Δn2 are calculated by solving the two equations. Thus, the change of only at the metal layer surface excluding the change at the solvent part can be properly measured.

Specifically, since the change Δλ1 in the resonance peak is determined by the change Δn1 in the index of refraction in the vicinity of the metal film and the change Δn2 in the index of refraction of the solvent part, if the thickness of the metal particle layer is known, the change λ1 in the resonance peak can be expressed as:
Δλ1=F(Δn1,Δn2) (1).

Similarly, since the change Δλ2 in the resonance peak is determined by the changes Δn1 and Δn2 in the index of refraction, the change Δλ2 in the resonance peak can be expressed as:
Δλ2=G(Δn1,Δn2) (2).

The functions F and G are experimentally obtained in advance. The changes Δn1, Δn2 in the index of refraction can be obtained from the changes Δλ1, Δλ2 in the wavelength by solving the equations (1) and (2) since the changes Δλ1 and Δλ2 in the wavelengths can be measured in the hybrid mode.

The method of manufacturing the metal layer 103 used in the present embodiment will now be described.

The first manufacturing method includes a step of cleaning the substrate made of glass or resin, a step of forming a gold thin film on the substrate through deposition or sputtering, a step of forming a monolayer of dithiol (e.g., 1, 10-decandithiol) on the metal thin film, and a step of immersing the substrate into a liquid solution of gold particles. According to this manufacturing method, the gold particles are immobilized at the gold thin film by way of dithiol.

The second manufacturing method includes a step of cleaning the substrate made of glass or resin, a step of immersing one surface of the substrate into the liquid solution of aminosilane coupling agent (e.g., 3-aminopropyltrimethoxysilane), a step of immersing the relevant surface into the liquid solution of gold particles, a step of cleaning the substrate, and a step of forming a metal thin film on the relevant surface through sputtering or deposition. In the present manufacturing method, the gold particles are first immobilized on the substrate, and then the flat part 109 made of gold thin film is formed between the gold particles.

### EXAMPLE 2

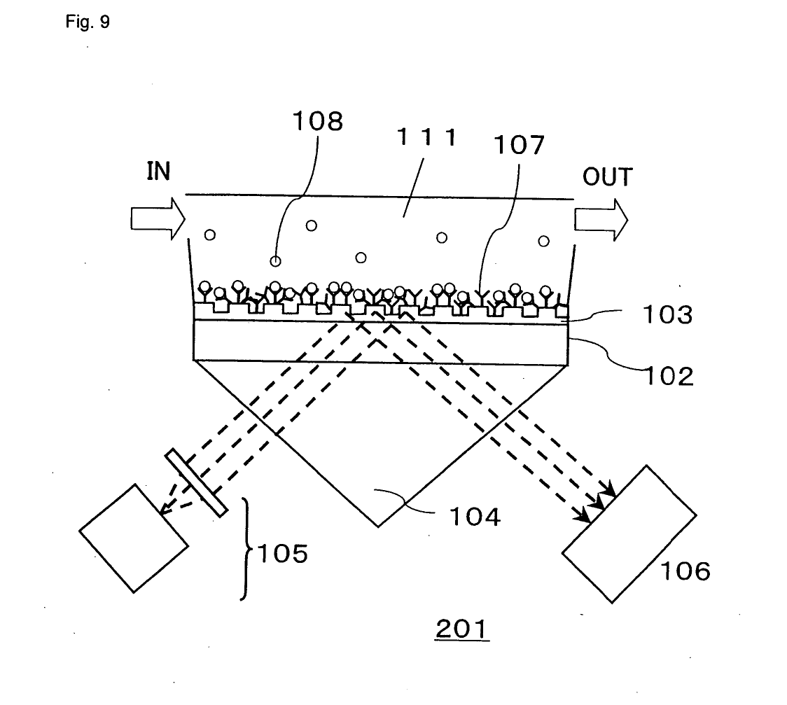

FIG. 9 shows a schematic side view of a surface plasmon resonance sensor 201 according to a second embodiment of the present invention. The present embodiment differs from the first embodiment in the configuration of the metal layer 103. The metal layer 103 in the present embodiment is obtained by forming a metal thin film on a flat surface of the substrate 102, and forming microscopic concave and convex parts on the metal thin film through etching and the like. The concave parts are formed so as not to pass through the metal thin film. The effects similar to the first embodiment are obtained since the electric field is localized in the vicinity of the concave parts or the convex parts even when such metal layer 103 is used.

The shape and the arranging distance of the microscopic concave and convex parts are not limited to those shown in FIG. 9 and may be appropriately selected.

### EXAMPLE 3

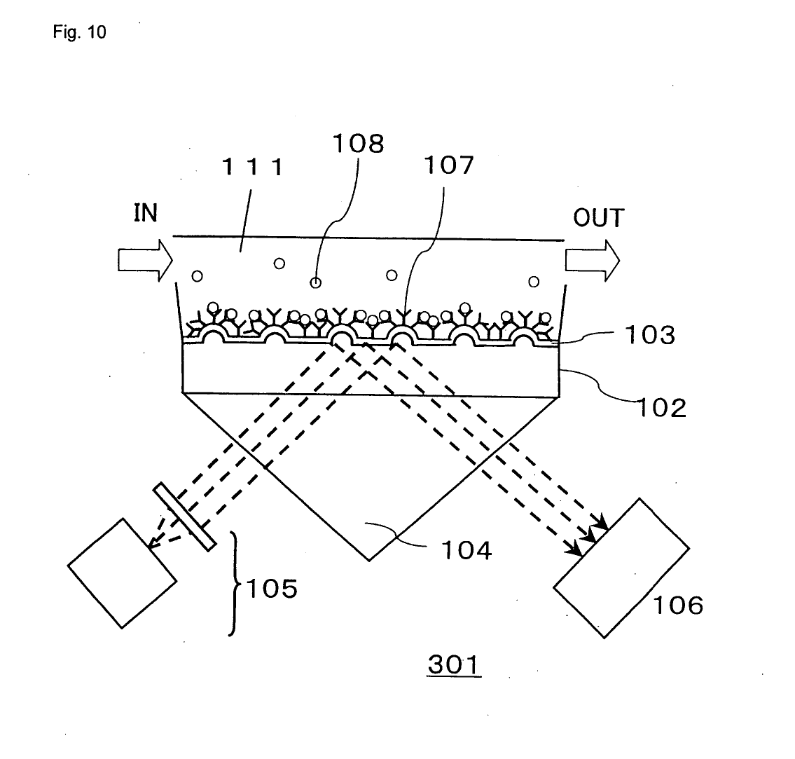

FIG. 10 shows a schematic side view of a surface plasmon resonance sensor 301 according to a third embodiment of the present invention. The present embodiment differs from the first embodiment in the configuration of the substrate 102 and the metal layer 103. In the present embodiment, a plurality of microscopic convex parts or microscopic concave parts are formed spaced apart from each other on the surface of the substrate 102, and the metal layer 103 is formed on the substrate 102 so as to reflect the shape of the microscopic convex parts or the microscopic concave parts. The effects similar to the first embodiment can be obtained since the electric field is localized in the vicinity of the concave parts or the convex parts even when such metal layer 103 is used.

The substrate 102 formed with microscopic concave and convex parts on the surface used in the present embodiment may be formed or copied by taking the shape of the biomolecules such as metal particles or proteins.

### INDUSTRIAL APPLICABILITY

The surface plasmon resonance sensor according to the present invention is obviously effective in detecting the presence and the extent of interaction in the antigen-antibody reaction, but is also applicable in analyzing various biochemical reactions.

1. A surface plasmon resonance sensor chip comprising:
a transparent substrate; and
a metal layer including concave parts or convex parts on a surface and a flat part positioned between the concave parts or the convex parts, and formed so as to cover the surface of the substrate; wherein
the depth and the width of the concave part or the height and the width of the convex part are greater than or equal to 20 nm and less than or equal to 150 nm.

2. The surface plasmon resonance sensor chip according to claim 1, wherein the substrate is a substrate with a flat surface, and the convex parts are a plurality of metal particles immobilized spaced apart from each other on a metal thin film, which is the flat part.

3. The surface plasmon resonance sensor chip according to claim 1, wherein the substrate is a substrate with a flat surface, and the concave parts or the convex parts are a plurality of microscopic concave parts and convex parts formed spaced apart from each other on a metal thin film, which is the metal layer, the concave part not passing through the metal thin film.

4. The surface plasmon resonance sensor chip according to claim 1, wherein a plurality of microscopic convex parts or microscopic concave parts are formed spaced apart from each other on one surface of the substrate, and the metal layer is formed on the one surface of the substrate so as to reflect the shape of the microscopic convex parts or the microscopic concave parts.

5. The surface plasmon resonance sensor chip according to claim 1, wherein the material of the metal layer is gold or silver.

6. A method of manufacturing a surface plasmon resonance sensor chip, the method comprising the steps of:
forming a metal thin film on one surface of a substrate through sputtering or deposition;
chemically modifying the surface of the metal thin film; and
immersing the chemically modified substrate into a liquid solution of metal particles.

7. A method of manufacturing a surface plasmon resonance sensor chip, the method comprising the steps of:
immersing one surface of a substrate in a liquid solution of aminosilane coupling agent;
immersing the substrate into a liquid solution of metal particles;
cleaning the substrate; and
forming a metal thin film on the one surface through sputtering or deposition.

8. A surface plasmon resonance sensor comprising:
a surface plasmon resonance sensor chip according to any one of claims 1 to 5;
a prism arranged on the side of the chip not formed with the metal layer;
a light source for irradiating light on the chip through the prism; and
a light detector for measuring the reflectivity of the light by the metal layer.

9. A method of measurement using the surface plasmon resonance sensor chip according to claim 1 to 5; the method comprising the steps of:
contacting sample solution to the metal layer side of the sensor chip;
irradiating the light having different frequency or angle of incidence from the side of the chip not formed with the metal layer from an optical system towards the chip;
detecting the light totally reflected at the interface of the metal layer and the substrate with a light detector;
obtaining at least two resonance frequencies or resonance angles from the intensity of the totally reflected light detected with the light detector; and
simultaneously measuring the change in the index of refraction of the sample solution in the vicinity of the surface of the metal layer based on the change in one of the resonance frequency or the resonance angle from the changes in the two resonance frequencies or the resonance angles and the change in the index of refraction of the sample solution not in the vicinity of the surface of the metal surface based on the change in the other resonance frequency or the resonance angle.

10. The method of measurement according to claim 9, wherein
the sample solution contains biomolecules;
the method further comprising the step of immobilizing acceptors on the metal layer of the sensor chip; and
the presence and the extent of interaction between the biomolecules and the acceptors are obtained based on the change in the index of refraction of the sample solution in the vicinity of the surface of the metal layer.
